(19) United States
(12) Patent Application Publication
(10) Pub. No.: US 2012/0072203 A1
(43) Pub. Date: Mar. 22, 2012

(54) System and method for using first language input to instantly output second language

(75) Inventors: Chaucer Chiu, Taipei (TW); Huchen Xu, Shanghai (CN)

(73) Assignee: INVENTEC CORPORATION, Taipei (TW)

(21) Appl. No.: 12/928,590

(22) Filed: Dec. 14, 2010

(30) Foreign Application Priority Data
Sep. 21, 2010 (TW) 099131984

(51) Int. Cl. G06F 17/28

(52) U.S. Cl. 704/2

(57) ABSTRACT

A system and a method for using first language input to instantly output second language are provided. The system and the method continuously receive input words in the first language and find the corresponding translation words in the second language according to the stored words, and then output the translation words. When receiving an adjustment signal, the system and the method readjust the order of outputted translation sentences within a selected range and update the output. Therefore, the system and the method can enhance the effect of instant translation.

### BACKGROUND OF THE INVENTION

1. Field of Invention

The invention relates to a translation system and the method thereof. In particular, the invention relates to the translation system that uses first language input to instantly produce second language output. During a dynamic input process, the system readjusts the order of outputted translation words and translation sentences. The invention also relates to the translation method of the above.

2. Related Art

As people in modern life frequently encounter many different languages, there are various kinds of translation software. In existing translation software that translates first language input into second language output, it generally first receives a first language sentence or paragraph that is completely entered. Afterwards, it converts the first language sentence or paragraph in a batch and outputs the result. This is static language translation. Alternatively, it suggests related second language data while the user enters first language. The user can refer to the suggested data during the input, so that the translation words or translation sentences in the second language are outputted to a specific target position.

The above-mentioned translation methods are claimed to be instant translation. However, the processing of translation has to completely separate inputting the first language words or sentences from outputting the second language words or sentences. The user cannot generate the second language output while entering the first language words or sentences concurrently. Therefore, the prior art is not completely instant translation. It is imperative to provide a better solution.

### SUMMARY OF THE INVENTION

In view of the foregoing, the invention discloses a system that uses first language input to instantly produce second language output and the method thereof.

The disclosed system for using first language input to instantly produce second language output includes: a language database pre-established with grammatical rule definitions and at least one word item for conversion between the first language and the second language; a receiving module for receiving at least one input word in the first language entered by the user and for receiving an adjustment signal; a translating module for comparing each of the input words with the word items, and then extracting the corresponding translation words in the second language, and then readjusting the order of the translation words according to the grammatical rule definitions and the word items; an outputting module for outputting the translation words or translation sentences; and a reading module for reading the translation sentence composed of the outputted translation words within a user selected range when the receiving module receives the produced adjustment, wherein the order of the translation words in the translation sentence is then readjusted by the translating module and outputted by the outputting module to replace the original outputted translation sentence.

According to the disclosed system, the adjustment signal is produced when no input word is received within a time period, a punctuation character or paragraph break character is received, or the user triggers an adjustment procedure. The disclosed system can further include a language switching module and a recording module. The language switching module enables the user to set the first language and the second language. The recording module records the input translation words updated by the user to the language database.

The disclosed method for using first language input to instantly produce second language output includes the steps of: pre-establishing a language database that contains grammatical rule definitions and at least one word item for conversion between the first language and the second language; receiving at least one input word in the first language, comparing each of the input words with the word items, extracting the translation words in the second language that correspond to the input words, and outputting each of the translation words; and, when an adjustment signal is produced, reading the translation sentence composed of the translation words within a user selected range, readjusting the order of the translation words in the translation sentence according to the grammatical rule definitions and the word items, and updating the output.

According to the disclosed method, the adjustment signal is produced when no input word is received within a time period, a punctuation character or paragraph break character is received, or the user triggers an adjustment procedure. The disclosed method can further include the step of providing a language switching interface for setting the first language and the second language. The disclosed method can further include the step of recording the input translation words updated by the user to the language database.

The system and method disclosed herein differ from the prior art in that the invention continuously receives first language input words, compares the input words with word items, and extracts the matched second language translation words to output. When the adjustment signal is produced, the invention readjusts the order of translation words in the translation sentence within the selected range and updates the output.

Through the above-mentioned techniques, the invention can enhance the effect of instant translation.

### BRIEF DESCRIPTION OF THE DRAWINGS

The invention will become more fully understood from the detailed description given herein below illustration only, and thus is not limitative of the present invention, and Wherein:

FIG. 1 is a block diagram of the disclosed system of using first language input to instantly produce second language output;

FIG. 2 is a flowchart of the disclosed method of using first language input to instantly produce second language output; and

FIGS. 3A to 3C are schematic views of an input process in an embodiment of the invention.

### DETAILED DESCRIPTION OF THE INVENTION

The present invention will be apparent from the following detailed description, which proceeds with reference to the accompanying drawings, wherein the same references relate to the same elements.

Those Chinese characters shown in the drawings are just mentioned for describing the embodiments and are substantially irrelevant to any technical matters.

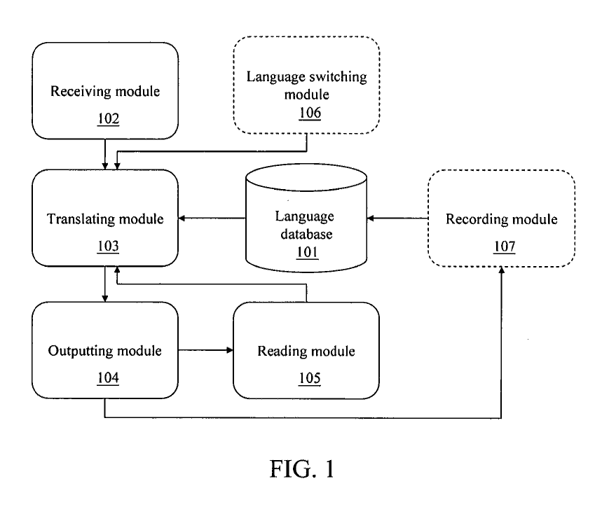

Please refer to FIG. 1, which is a block diagram of the disclosed system that uses first language input to instantly produce second language output. It explains the relations of the modules in the invention. The disclosed system includes: a language database 101, a receiving module 102, a translating module 103, an outputting module 104, and a reading module 105.

The language database 101 is pre-established with grammatical rule definitions and at least one word item for conversion between the first language and the second language. The grammatical rule definitions for conversion between the first language and the second language refer to the rules of singular or plural forms, sentence types or other grammatical rules. The word item for conversion between the first language and the second language includes at least an original word in the first language and a translation word along with its syntactical function and explanation in the second language corresponding to the original word. Besides, the first language and the second language are the language translation relation predetermined by the system. For example, in the system that takes English input and produces Chinese output, the first language is English and the second language is Chinese. As there are many languages in the world, the invention does not impose any restriction on the first language and the second language.

The receiving module 102 continuously receives at least one input word in the first language entered by the user and an adjustment signal.

The translating module 103 compares the input words received by the receiving module 102 with the word items in the language database 101 and extracts the corresponding translation words. According to the grammatical rule definitions and word items, it readjusts the order of the translation words in translation sentence. It should be noted that the translating module 103 makes a corresponding conversion of the input words between the first language and the second language according to the word items. The rule definitions of grammatical rules include the change in the singular and plural forms, the order of subject and object, etc. Since the conversion between different pairs of language involve different grammatical rule definitions, the invention does not restrict the content of grammatical rule definitions.

The outputting module 104 outputs the translation words or translation sentence produced by the translating module 103.

The reading module 105 reads the translation sentence composed of at least one of the output translation words within a user selected region when the receiving module 102 receives an adjustment signal. When the user does not enter any word, any punctuation or a paragraph breaking character within a time period, or when the user starts an adjustment procedure, the system generates an adjustment signal. In this case, the reading module 105 reads the translation sentence within the user selected range. According to the grammatical rule definitions and the word items, the translating module 103 readjust the order of the translation words in the translation sentences within the selected range.

In addition to the above-mentioned modules, the invention can also have a language switching module 106 and a recording module 107.

The language switching module 106 provides the setting of the first language and the second language used by the translating module 103. Suppose originally the first language is Chinese and the second language is English in the language database. The user can use the language switching module 106 to set the first language as English and the second language as Chinese. Since the arrangement of languages in the language database 101 has been explained before, it is not further described hereinafter.

The recording module 107 records the translation words updated by the user to the language database 101. Suppose the translation words or translation sentences extracted by the translating module 103 do not match the meaning that the user wants to express, the user can directly modify the output translation words or translation sentences. In this case, the recording module 107 can record the modifications done by the user to the language database 101, so that they can be data for the translating module 103 to adopt during a future translation.

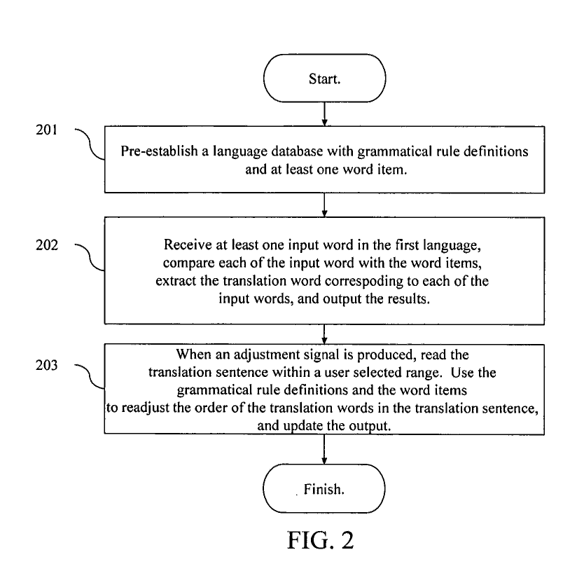

Please refer to FIG. 2 for the flowchart of the disclosed method for using first language input to instantly produce second language output. An embodiment is used to explain how the invention is implemented in detail. For some translation software implemented with the invention, the translation software has to pre-establish a language database containing grammatical rule definitions and at least one word item for conversion between the first language and the second language (step 201). The grammatical rule definitions for conversion between the first language and the second language refer to the rules of singular or plural forms, sentence types or other grammatical rules. The word item for conversion between the first language and the second language includes at least an original word in the first language and a translation word along with its syntactical function and explanation in the second language corresponding to the original word. Besides, the first language and the second language are the language translation relation predetermined by the system. For example, in the system that takes English input and produces Chinese output, the first language is English and the second language is Chinese. As there are many languages in the world, the invention does not impose any restriction on the first language and the second language. Afterwards, the method receives at least one input word in the first language entered by the user, compares each of the input words with the word items, extracts the corresponding translation words in the second language, and outputs the results (step 202).

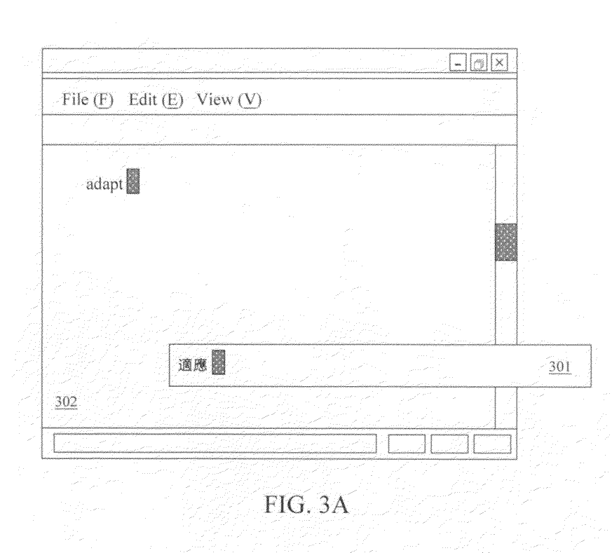

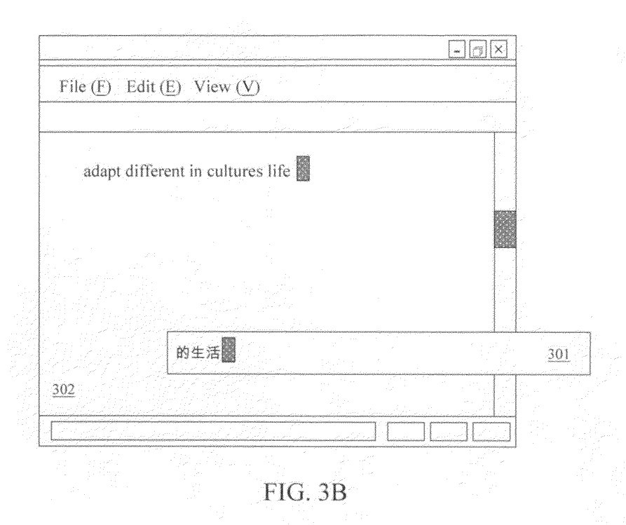

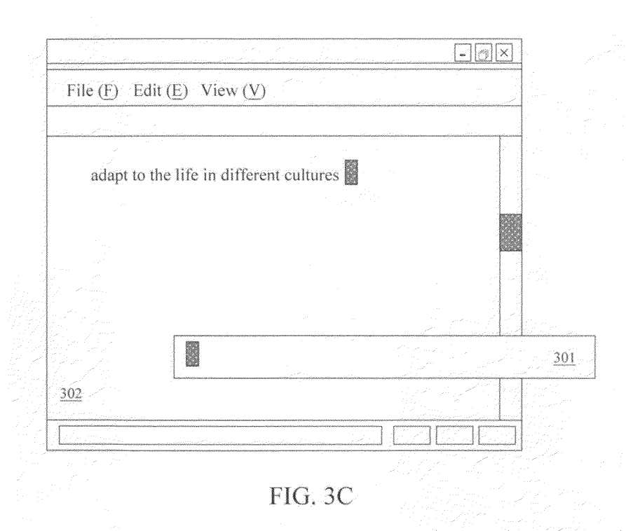

Please simultaneously refer to FIGS. 2 and 3A. Suppose the user starts translation software implemented with the invention while editing a word document. Moreover, the user adopts the scheme of using Chinese first language input to instantly produce English second language output. In the first language input interface 301, the user enters Chinese words. The output English words are directly output to the document editing interface 302. Suppose the user enters a word “adapt” in Chinese in the first language input interface 301. Then the translation software compares the Chinese word “adapt” with the word items in the language database. The comparison result gives the English word “adapt.” The translation software then output the translation word “adapt” to the document editing interface 302.

Moreover, when the user continuously enters other Chinese words, such as “adapt”, “different”, “culture”, and “one's life” (only the Chinese word “one's life” is illustrated in the first language input interface 301 of FIG. 3B). In this case, the translation software compares with the word items in the language database and obtains the translation words “adapt,” “different,” “in cultures,” and “life.”

When the user does not enter any Chinese word, punctuation character or paragraph breaking character within a certain period of time, or the user triggers the function of adjusting the order of a translation sentence in the translation software, an adjustment signal is then produced. Please refer to FIG. 3C. Suppose the user does not enter any Chinese word within a time period, the translation software reads the translation sentence in a user selected range. Following the grammatical rule definitions and the word items, the method readjusts the order of the translations words in translation sentence and updates the output (step 203). Suppose in this embodiment the user selected range is the complete output translation sentence. The translation software adjusts the word order in “adapt different in cultures life” into “adapt to the life in different cultures” and updates the output.

In addition to the above-mentioned steps, the disclosed method further provides a language switching interface for changing the input language and the output language. Although Chinese and English are used in this embodiment, the changeable languages can be set according to the practical needs in the translation software.

Besides, when the user directly changes the contents of the translation sentence in the document editing interface, the invention can further records the user updated translation words to the language database for the reference of future translation.

In summary, the invention differs from the prior art in that it continuously receives words entered in the first language, and compares them with the word items. The matched translation words in the second language are extracted and outputted. When there is an adjustment signal, the invention readjusts the order of the translation words in the translation sentence within the selected range and updates the output. The disclosed techniques can solve problems in the prior art, and thus enhance the effect of instant translation.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system of using first language input to instantly produce second language output, comprising:
a language database pre-established with grammatical rule definitions and at least one word item for conversion between the first language and the second language;
a receiving module for receiving at least one input word in the first language entered by a user and for receiving an adjustment signal;
a translating module for comparing each of the input words with the word items, and then extracting the corresponding translation words in the second language, and then readjusting the order of the translation words according to the grammatical rule definitions and the word items;
an outputting module for outputting the translation words or translation sentences; and
a reading module for reading the translation sentence composed of the outputted translation words within a user selected range when the receiving module receives the produced adjustment signal, wherein the order of the translation words in the translation sentence is then readjusted by the translating module and outputted by the outputting module to replace the original outputted translation sentence.

2. The system of using first language input to instantly produce second language output according to claim 1, wherein the adjustment signal is produced when no input word, punctuation character or paragraph breaking character is received within a certain period of time or when the user triggers an adjustment procedure.

3. The system of using first language input to instantly produce second language output according to claim 1 further comprising a language switching module for setting the first language and the second language.

4. The system of using first language input to instantly produce second language output according to claim 1 further comprising a recording module for recording the translation words updated by the user to the language database.

5. A method for using first language input to instantly produce second language output, comprising the steps of:
pre-establishing a language database that contains grammatical rule definitions and at least one word item for conversion between the first language and the second language;
receiving at least one input word in the first language, comparing each of the input words with the word items, extracting the translation words in the second language that correspond to the input words, and outputting each of the translation words; and
when an adjustment signal is produced, reading the translation sentence composed of the translation words within a user selected range, readjusting the order of the translation words in the translation sentence according to the grammatical rule definitions and the word items, and updating the output.

6. The method for using first language input to instantly produce second language output according to claim 5, wherein the adjustment signal is produced when no input word, punctuation character or paragraph breaking character is received within a certain period of time or when the user triggers an adjustment procedure.

7. The method for using first language input to instantly produce second language output according to claim 5 further comprising the step of providing a language switching interface for setting the first language and the second language.

8. The method for using first language input to instantly produce second language output according to claim 5 further comprising the step of recording translation words updated by the user to the language database.
